(19) United States
(12) Patent Application Publication
(10) Pub. No.: US 2007/0262594 A1
(43) Pub. Date: Nov. 15, 2007

(54) Padlock with security seal

(75) Inventors: Barry Hudson, Melbourne (AU); Donald R. Casterline, Mountain Top, PA (US)

Correspondence Address: BRADLEY N. RUBEN, PC, 463 FIRST ST, SUITE 5A, HOBOKEN, NJ, 07030, US

(73) Assignee: TEBCO PTY LIMITED

(21) Appl. No.: 11/429,174

(22) Filed: May 5, 2006

(51) Int. Cl. E05B 39/02

(52) U.S. Cl. 292/328

(57) ABSTRACT

A padlock is provided with a disposable seal indicating whether the padlock has been opened. The seal can be provided with indicia identifying the last entity to seal the padlock, and so is useful for luggage security during travel.

### BACKGROUND OF THE INVENTION

This invention relates to tamper evident locks, especially for security bags and the like, and especially of the padlock variety.

A padlock is a detachable lock having a lock body and a moveable shackle designed to cooperate with a staple or ring fixed to an object. The shackle is slidably or hingeably connected to the lock body. In a removable padlock, the shackle can be freed from the lock body, often in part, by mechanical alignment of one or more locking tumblers. Such arrangements are found in conventional combination locks as well as keyed tumbler locks, whose position must be changed to allow repositioning of the shackle.

A typical keyed or combination padlock is a fairly secure device, and is usually overcome by being bypassed (such as having the shackle cut, or by use of a shim) rather than being picked. Nevertheless, various devices for securing padlocks do exist. U.S. Pat. No. 2,666,318 describes a keyed padlock having a hole drilled through the case, including the keyway, and a wire loop sealed through the hole, whereby a key can be inserted the length of the keyway only by cutting and removing the wire loop. U.S. Pat. No. 1,659,433 and U.S. Pat. No. 3,572,063 each describes a conventional keyed padlock having a sealing strip secured outside of the lock and covering the keyway, whereby the strip must be cut to provide access to the keyway. There are various non-frangible covers for keyed locks, such as described in U.S. Pat. No. 5,109,686, U.S. Pat. No. 5,758,529, and U.S. Pat. No. 3,680,337. Also disclosed are frangible, single use seals for locks, such as in GB 2,064,638 (and GB 2,355,233 for locks associated with zippers), wherein a disposable plastic seal is positioned over the keyway and broken away in order to access the lock.

Present security measures exercised at departure points (typically airports), especially in the United States, where such security is administered by the Transportation Security Authority (TSA), require that individuals submit their person and accessible property to screening and searching. In addition, each airport operator must establish a secure area and have a security program. The security measures, many of which are well-known to travelers, include screening and possible searching of carry-on luggage, as well as screening and possible searching of checked luggage. To allow passengers to maintain secured luggage, but allow airport and/or TSA security agents to search luggage, various manufacturers have developed locks that are “approved and recognized” by TSA (information presently available at http://www.tsa.gov/). That TSA website also notes TSA has the ability to open some locks that are not listed, but time pressures may require screeners to cut locks because there are multiple master keys for a multitude of locks that can be opened, and/or are “approved and recognized,” by TSA. At the time of this filing, the TSA recognizes only locks provided by Travel Sentry LLC (Washington, D.C.) and Safe Skies LLC (Brooklyn, N.Y.) as approved locks. These locks are side tumbler combination padlocks with the addition of a keyway allowing authorized TSA security personnel to use a key to open the lock. Thus, even with a master key and an approved lock, the lock shackle may still be cut due to time pressures. Accordingly, it would be useful to provide a lock having some indication of tampering, and that is easy for the user and a security authority to open. It would be of further benefit to provide a lock where the searching authority can readily determine that the lock has been opened and resealed by that searching authority or another searching authority.

### SUMMARY OF THE INVENTION

In light of the foregoing, what is not disclosed in the art is a simple to use padlock having a security feature, and especially a disposable, easy to use security feature that evidences tampering, and optionally also allows for further information, such as a security identification or bar code, to be used on the security tag. Also not disclosed is a simple, inexpensive, and easy to use lock that is suitable for use as a TSA-approved lock.

In one embodiment, this invention provides a padlock having a releasable shackle and a lock body, the lock body having an outer portion defining a recess adapted for accepting a security seal, a release mechanism for the shackle activated from the outer portion of the lock body, and a passage from said recess into the lock body, the release mechanism utilizing a portion of the passage, and wherein a seal disposed in the recess and having a portion extending into the passage interferes with the function of the release mechanism, whereby the seal must be removed for the release mechanism to function.

In a simplified version, the invention provides a simple padlock having a replaceable breakaway seal that interferes with the opening of the lock when the seal is in place. Without the seal, the padlock is a simple padlock, having a spring-loaded shackle that is released by a simple lever, button, or thumbscrew. When the seal is in place, the release mechanism does not work and the lock will not open. The seal can be relatively easily broken away (like any tamper-evident seal, relatively easy for the consumer to break but sufficiently robust to withstand shipping and handling) allowing the release mechanism to work. The seal can be replaced, and by using indicia (such as colors, bar codes, holograms, and the like, and combinations thereof) the searching authority, airline, and/or passenger can determine the last entity to seal the lock (and whether the lock is unsealed).

### BRIEF DESCRIPTION OF THE FIGURES

FIGS. 1A and 1B depict perspective views of the front and back of a padlock according to this invention.

FIG. 2 is a cross section taken along line 2-2 in FIG. 1A.

FIG. 3 is a cross section taken along line 3-3 in FIG. 1A.

FIG. 4 is a cross section taken along line 4-4 in FIG. 1A.

FIG. 5 is a bottom view of the release of the embodiment shown in FIG. 2A.

FIG. 6 is a bottom view of another embodiment of a release.

### DETAILED DESCRIPTION OF SPECIFIC EMBODIMENTS

This invention is described with reference to a simple padlock, having a pawl mechanism that maintains the shackle in a locked position, a rotatable release for the shackle, and adapted to accept a security seal that interferes with the release.

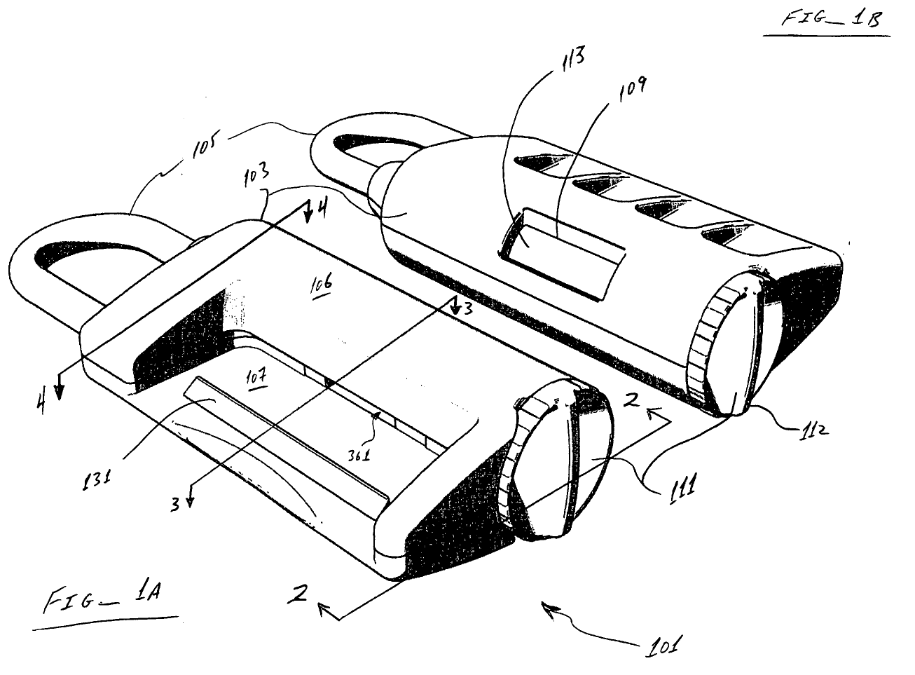

As shown in FIGS. 1A and 1B, front and back views of one embodiment of this invention, the lock 101 includes a lock body 103 within which a shackle 105 is slidably secured. The lock body has an exterior 106, a portion of which defines a recess 107 or receptacle adapted to receive a security seal. On the opposing side of the body from the recess is a window 109 also formed in the exterior. A release 111 for actuating a release mechanism for the shackle is accessed at the exterior, and includes a wall portion 113 that obscures the exterior window during normal operation.

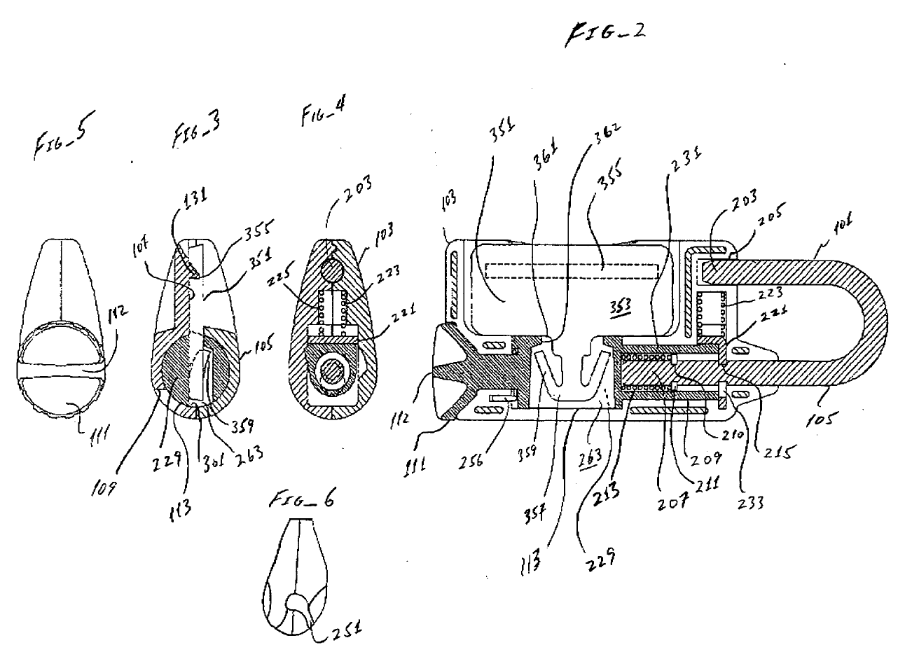

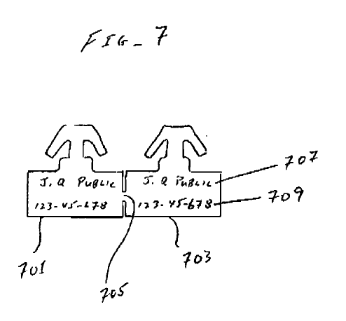

The release can have various forms, two very similar embodiments of which are described herein, and has three portions: the release exterior of the body actuated by the user; a middle chamber handling the security seal; and a portion releasably engaging the shackle. As shown in FIG. 2, a cross section taken along line 2-2 in FIG. 1, the shackle 105 has a first free end 203 disposed in a first bore 205 in the body of the lock, and a second end 207 disposed in a second bore 209 disposed in the body, so that both ends of the U-shaped shackle can be simultaneously slid into and out of the respective bores. The second end of the shackle includes a first channel, groove, furrow, or the like in which a flange 211 is disposed defining an endpoint of a volume in the second bore in which spring 213 is disposed. This spring fits between the flange and the end of a chamber formed in the second bore and defined by the frame (see below), and tends to release the shackle, biasing the shackle towards the right in FIG. 2 whereby, if moved in that direction, the free end would clear the first bore. The second end of the shackle also contains a second groove, channel, or furrow 215 that cooperates with a pawl 221 (see also FIG. 4) that is shown in FIG. 2 movable orthogonal to the direction of movement of the shackle, and held in a position by a second spring 223; this second spring is housed in a volume 225 adjacent the pawl.

The release mechanism is shown as having a thumbscrew or knob in FIGS. 1A, 1B, 2, and 5, but can also take the form of a simple lever or arm 251 as seen in FIG. 6. The actuating portion of the release is connected to a structure including a wall 113 that normally obscures the window in the exterior of the body, and is further connected via frame 229 to an arm structure 231. As shown in FIG. 2 the has a portion forming a volume that receives the second end of the shackle and accommodates the first spring and flange. The arm structure also engages pawl 221 and moves the pawl effective to release its catch on the second groove of the shackle. Thus, by moving the pawl against its abutting spring 223, an open space 233 bounded by a portion of the pawl structure then is disposed about the second end of the shackle allowing it to be free from the pawl and, by virtue of the spring 213, the shackle is caused to be moved out from the lock body (towards the right in the drawing). When the shackle is reinserted, the insertion force causes compression of the first spring 213 and eventually slides the second groove into alignment with the pawl so that the pawl re-engages the second channel in the second end of the shackle, locking the shackle in a closed position. As shown in FIG. 4, a cross-section through lines 4-4 in FIG. 1A, the preferred movement of the release is rotation about an axis essentially co-axial with the second end of the shackle, and this rotation can be affected using any type of actuator, whether similar to a thumbscrew or knob or the end of a lever.

FIG. 3, a cross section taken through lines 3-3 in FIG. 1A, depicts the presence of a removable or disposable security seal 351. As shown in FIG. 2. the frame 229 connects the release actuator 111 to the release arm (that engages the pawl) and includes a wall 113 that normally obscures the window 109. As the frame is rotated, an opening 301 in the frame rotates adjacent or in alignment with the window to provide an unobstructed passage through the window into cavity 263 in the frame.

As seen in FIGS. 2 and 3, a preferred embodiment the seal 351 provides a generally rectangular flat body 353 having a groove 355 in one surface (or an opening through the flat body likewise providing a recess or groove). The seal body extends forward to a head 357 having one or more pawls 359 that cooperate with a passage 361 in the lock body. Cooperation of the pawls with the shoulders 362 partially defining the cavity in the frame retains the seal after the head has been pushed through the passage into the cavity 263. The groove in the seal body cooperates with a ridge 131 upstanding from the recess 107 in the outer lock body to provide an audible snap when the seal is in place and flush with the recess. As seen in FIG. 3, the pawl on the seal catch is normally out of the plane of the seal body, and as it passes through the passage, the pawl arm will snap up into the cavity, locking the seal in place and also providing an audible indication that the seal is secured.

FIGS. 5 and 6 are bottom views of different embodiments of the release actuator. In FIG. 5 the actuator includes a ridge 112 making the actuator like a thumbscrew used to rotate the frame, as seen in FIGS. 1A and 1B, and in FIG. 6 the actuator has a lever 251 pressed to rotate the frame. The actuator is preferably biased, by using a spring or elastic material, to keep the actuator in the position contrary to removing engagement of the pawl with the shackle (that is, it is biased to the normally closed position). As shown in FIG. 2, spring 256 has one end fixed to the lock body and a curved portion orthogonal thereto extending essentially circumferentially around the frame and fixed thereto.

With the seal in place, the release, and thus the frame, cannot be rotated to release the internal pawl holding the shackle. In use, the seal body is snapped off from the head, using the passage in the body as a fulcrum. The seal body can be removed by the user. Separating the head from the seal body allows the frame to be rotated using the release, ultimately releasing the shackle. Simultaneously, rotation of the frame opens the rear window from which the separated head of the seal (held in the cavity) is ejected or can be removed.

The present lock, useful as a TSA approved lock, thus acts primarily as an indicator whether baggage has been opened and/or searched because the seal must be broken in order to unlatch the shackle. In use, the seal preferably includes indicia printed thereon. For example, seals having the luggage owner's name and address, or other indicia, can be provided or created by the traveler: standard adhesive labels printable on a printer attached to a home computer can be readily made (and adhesive labels of various sizes can be found in office supply stores or readily manufactured in the industry), and the owner can print identifying information on the labels and adhere the labels to blank seals. Similar with printing an electronic airline ticket at a peripheral printer on a home computer, bar codes indicating the passenger and flight number (or other related information) can be printed on labels then adhered to blank seals. Different seals can be used to identify the last entity (person, organization, or part thereof to open and/or search the luggage. This system, the combination of the padlock and an identifying replaceable seal, provides increased security because it can be immediately determined whether or not an article of luggage was searched if the original seal is missing or replaced. Who searched the luggage can be determined if a new seal is put in place and the new seal has indicia specific to the searching authority (or whoever last sealed the lock). In addition, for example, when the traveler first checks baggage, the carrier can substitute the traveler's seal with a seal indicating that the luggage has been checked but not yet searched. Thereafter, another seal with different indicia indicating that the luggage has actually been searched can be used by the searching authority prior to loading the luggage on the plane. Then, upon landing, a traveler claiming the luggage can determine the last entity to have searched the luggage in case any items are later found missing (although the items may have been removed by some intermediate search). This system thus provides a simple mechanism by which it can be determined whether the luggage was possibly opened (the seal is removed) or searched and the last entity sealing the luggage (if a new seal is provided).

The recess in the lock body protects the seal from unintentional breakage by virtue of the upstanding side walls.

As an additional advantage of the present invention, security personnel do not have to fumble with dozens of master keys to find the correct one for opening an “approved” lock (and so avoid the problems identified in published reports of approved locks being cut off by security personnel, likely because they have only a limited amount of time to search through a piece of luggage and do not want to waste time searching for the proper master key). Even for luggage on which a padlock is not suitable, if there is a staple and hasp on the luggage, then a simple relatively permanent plastic band or line, such as a plastic cinch or cinch buckle, can be provided through the staple and secured with the present padlock. The padlock is then secured with the replaceable ID tag, or seal, as described.

To facilitate more complete tracking, the luggage can be provided with a resealable or reclosable pocket on the outside of the luggage to hold removed seals. The pocket preferably has a transparent or translucent outer pocket wall to enable one to see if the discarded seals are present in the pocket. When the seal is broken off for a search or a change in custody (such as checking-in baggage), the body of the broken-off seal is deposited in the pocket, and then the baggage is re-secured with the padlock and preferably using a new seal, more preferably a new seal identifying that searching entity. If a TSA security agent (or any other security agent) then desires to search the same luggage, the existing seal is broken off and deposited in the pocket, and a TSA seal is used to re-secure the padlock after the luggage has been searched. The TSA, if finding a prohibited article in the luggage, can determine the last entity to seal the luggage (whether a traveler, a carrier, or a security agent). The traveler, upon claiming the luggage, if anything is missing, or has been added, possibly has broken seals in the pocket or a new seal securing the padlock, and can know whether the original seal on the padlock was removed. The use of a bar code or unique personal identifier by the carrier and/or TSA (or any security agent) can be used to identify the particular agent searching any given piece of luggage.

The instant invention also provides the advantage of being able to secure the luggage in a hotel room or when left at a concierge or the left luggage counter at an airport. The traveler need only insert a seal in the padlock prior to leaving the room (especially if the room does not have a safe, or the article is too large to fit into the safe) or leaving the luggage with the concierge.

The novel padlock has been described herein for use with luggage, and so the padlock body can be plastic, metal, or a combination; the shackle is preferably metal, the seal can be metal but is preferably plastic, and the release and frame can be metal or plastic. Of course, the padlock and seal can be made much larger, such as for securing shipping containers; alternatively, the lock can be more robust but the same seal as used for luggage can be used with a larger lock. In that case, the portion of the frame that cuts off the head of the seal would need to be strengthened and otherwise modified to cut the head from a larger seal. In addition, a levered tool (analogous to a bolt cutter, or like a crowbar for a jack) can be applied to the release to generate a force sufficient to cut the seal. An additional tool might be beneficial for inserting a new seal.

The foregoing description is meant to be illustrative and not limiting. Various changes, modifications, and additions may become apparent to the skilled artisan upon a perusal of this specification, and such are meant to be within the scope and spirit of the invention as defined by the claims.

1. A tamper evident padlock, comprising:
a padlock body having an outer surface including a recess adapted to retain a seal and having first and second openings comprising a passage (361) and a window (109) connected by a cavity (263);
a shackle having a first free end for engaging a containment recess in the outer surface of the padlock body, and a second end slidable within the padlock body;
securing means for releasably securing the second end of the shackle;
a release on the outer surface of the padlock body for releasing the securing means and including a frame extending from the outer surface to the securing means, said frame includes said cavity and said cavity normally operably associated with said first passage opening, and said cavity being operably associated with said second opening when the release is operated.

2. The padlock of claim 1, further comprising a spring for keeping the release biased in a normally closed position.

3. The padlock of claim 1, further comprising a spring for biasing the shackle into a normally opened position.

4. The padlock of claim 1, further comprising a ridge on the outer surface defining the recess, said ridge adapted to cooperate with a groove on said seal.

5. The padlock of claim 1, wherein said shackle is maintained in a closed position by a pawl housed within the padlock body, said pawl cooperating with a recess on the shackle.

6. The padlock of claim 5, wherein the release cooperates with the pawl to release the shackle.

7. The padlock of claim 5, wherein the pawl is biased to a position normally engaged with the shackle by a spring.

8. A tamper evident padlock system, comprising:
a padlock having a releasably engageable shackle slidable within the body of the padlock;
a seal having a body of a predetermined geometry and an engagement head;
a recess on the surface of the padlock having a geometry suitable for accepting the seal body, said recess accessible to a user of the padlock;
the padlock having a passage from the recess into the body adapted to accept the engagement head;
and means for releasing the shackle,
wherein a seal inserted in the recess and has an engagement head extending through the passage into the padlock body preventing said means for releasing the shackle.

9. The system of claim 8, wherein the padlock body further comprises a window opened by said means for releasing the shackle, wherein a seal head left in the padlock body by removal of the seal is removable from the padlock body through the window.

10. The system of claim 8, in the form of a kit further comprising a plurality of seals suitable for use with the padlock.

11. The system of claim 10, wherein at least one seal includes indicia identifying a person traveling, a common carrier, or a security authority.
